(19) United States
(12) Patent Application Publication
(10) Pub. No.: US 2004/0226587 A1
(43) Pub. Date: Nov. 18, 2004

(54) SAND REMOVAL SYSTEM

(76) Inventors: Michel Lemire, Lloydminster (CA); Zane Gingell, Lloydminster (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/249,912

(22) Filed: May 16, 2003

(51) Int. Cl. B08B 3/00

(52) U.S. Cl. 134/99.1

(57) ABSTRACT

A sand removal system for an oil storage tank includes an upper and lower pipe ring each having multiple nozzles for spraying a wash fluid. The nozzles are aimed to create a vortex or spiral motion within the tank and suspend the sand. A suction pipe with a centrally located inlet removes the wash fluid and suspended sand.

### BACKGROUND OF INVENTION

The present invention relates to an apparatus for removing sand and other particulate solids from a fluid storage tank. In particular, it relates to an apparatus for removing sand from a cylindrical oil storage tank.

In one method of heavy oil production, a mixture of water, oil and particulate solids is pumped from producing oil wells into an above-ground storage tank. The particulate solids are typically sand. The storage tank is heated to lower the viscosity of the heavy oil and allow the solid, aqueous and oil phases to separate. The sand settles at the bottom of the tank and the oil is periodically drained from the upper portion of the tank.

It is necessary to periodically clean the tank and remove the sand. Existing methods to remove the sand are laborious and time-consuming.

Therefore, there is a need in the art for an efficient sand-removal system for oil storage tanks.

### SUMMARY OF INVENTION

The present invention provides for sand removal system for use in an oil storage tank. Above-ground oil storage tanks are conventionally upright cylindrical tanks, however, the present invention may comprise or be installed in cylindrical or non-cylindrical tanks. Although sand is the primary solid which accumulates within oil storage tanks in most oil producing areas such as eastern Alberta, other solid particulate material such as shale or clay may also accumulate and may be removed by the present invention. In one aspect, the invention may comprise a particulate removal system for a vertically cylindrical fluid storage tank comprising:

(a) at least one nozzle disposed within the tank for directing a wash fluid in a circular motion within the tank;

(b) means for connecting the at least one nozzle with a supply of pressurized wash fluid;

(c) a particulate collection outlet centrally located within the tank.

In another aspect, the invention may comprise a fluid storage tank which comprises the particulate removal system described or claimed herein.

In another aspect, the invention may comprise a method of removing settled particulate matter from a fluid collection tank comprising the steps of:

(a) directing a pressurized wash fluid within the tank to mix with the particulate matter and create a fluid vortex;

(b) removing particulate matter and wash fluid by suction at the centre of the vortex.

The methods of the present invention may be implemented with the apparatus or systems described or claimed herein.

### BRIEF DESCRIPTION OF DRAWINGS

The invention will now be described by way of an exemplary embodiment with reference to the accompanying simplified, diagrammatic, not-to-scale drawing where:

FIG. 1 is a side view of one embodiment of a system of the present invention.

FIG. 2 is a top plan view of the embodiment of FIG. 1.

FIG. 2A is a top view of an alternative embodiment of the vanes.

FIG. 3 is a side view of pipe going through packing body, packing head, packing and lock nut for the top ring. FIG. 3 is another side view showing the pivoting motion of the wash pipe of one embodiment.

FIG. 4 is a top view of an alternative embodiment of the present invention.

FIG. 5 is a detailed view of an optional venturi nozzle.

### DETAILED DESCRIPTION

The present invention provides for a method and system for removing particulate solids from a fluid storage tank. The invention described herein is specifically designed to remove sand from heavy oil storage tanks but the claimed invention is not intended to be limited to that single purpose. The present invention will be described herein with reference to a cylindrical above ground storage tank and also may have application to underground tanks that are upright and cylindrical. As used herein, the term “horizontal” or “horizontally” shall refer to a plane or direction substantially perpendicular to the cylindrical axis of the storage tank and the term “vertical” or “vertically” shall refer to a plane or direction substantially parallel to the cylindrical axis. All other terms not specifically defined herein shall have their literal or art-accepted meanings.

In one embodiment, the invention comprises a method of removing sand. The inventors have unexpectedly found that by creating a fluid vortex by directing jets of wash fluid within the tank, the sand which has settled on the bottom of the tank is suspended and concentrates near the centre of the vortex. By applying suction at the centre of the vortex, a large proportion of the sand may be efficiently removed from the tank. This result is counter-intuitive because cyclonic action is used in the oil and gas industry to separate solids, liquids and gases by moving denser materials to the outside of a vortex, not the centre.

In one embodiment, the sand removal system is installed within a storage tank (T) as shown in the Figures. Although the present invention is particularly well adapted for cylindrical tanks, tanks with polygonal or square cross-sections may also be included in the scope of the claimed invention. The wash fluid may be water and may be provided using water tankers with pumps, as is well-known in the industry. Water is pumped into the system through a fitting (10) and piping (12) which leads to an upper pipe ring (14) and a lower pipe ring (16). A bull plug (11) is used to cap the fitting (10) when not in use. In the embodiment illustrated, the pipe rings are substantially circular to fit the cylindrical tank. In other embodiments, the pipe rings may be polygonal. As may be appreciated by one skilled in the art, polygonal pipe rings may be fashioned from lengths of straight pipe and angled couplings.

A valve (18) controls flow of water to the upper pipe ring, which another valve (20) controls flow of water to the lower pipe ring. Each of the upper and lower pipe rings have a diameter slightly less than the diameter of the tank and each include a plurality of nozzles (22) for directing water jets within the tank. Each pipe ring may be formed from two semi-circular lengths of pipe joined at one end by a standard coupling (21) and at the other end with a “T” coupling or fitting which also connects to the source pipe (12). The lower pipe ring (16) may supported on the tank floor by a plurality of brackets (17).

In one embodiment, the nozzles (22) on the upper pipe ring are directedidwnwardly and at an angle to create a spiral action. This directs the water jets into the sand, which assists in agitating and suspending the sand. The nozzles (22) are also directed sideways, the effect of which is to create a vortex with the fluid within the tank.

In a preferred embodiment, the nozzles (22) on the lower pipe ring (16) also are directed inwardly and sideways to assist in the creation of a vortex within the tank. The lower pipe ring nozzles are preferably directed substantially horizontally.

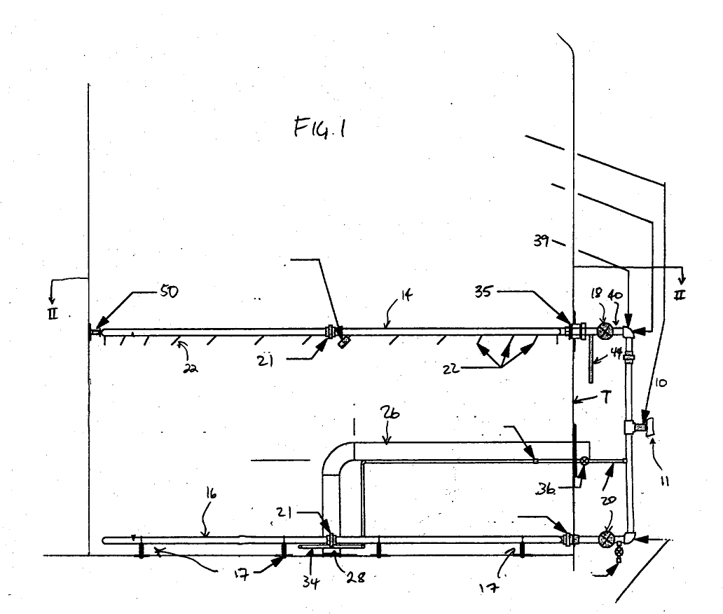

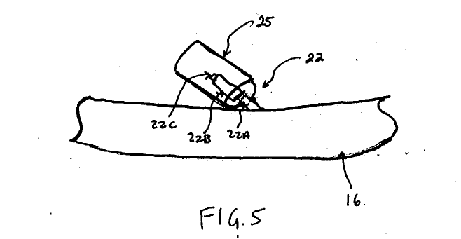

In a preferred embodiment, the nozzles (22) may comprise a jet pump action through a venturi (25) as illustrated in FIGS. 1, 2 and 5. As is well known in the art, when a high pressure fluid stream is directed into a tube or venturi, suction is created at one end of the tube (40). This venturi effect may be optionally employed in the present invention to increase the fluid flow of the nozzles. The venturi tube (25) may be welded to the pipe ring (14, 16) so as to encircle the nozzle (22). Each nozzle (22) comprise a coupling (22A), a nipple (22B) and a spray jet (22C).

In an alternative embodiment, pipe rings may be unnecessary. Nozzles or jets may be positioned within the tank by alternate means to agitate accumulated sand with a wash fluid and to create a swirling motion within the tank. In its simplest form, a single nozzle may be directed within the tank to create such agitation and fluid movement, if sufficient wash fluid volume and velocity can be employed.

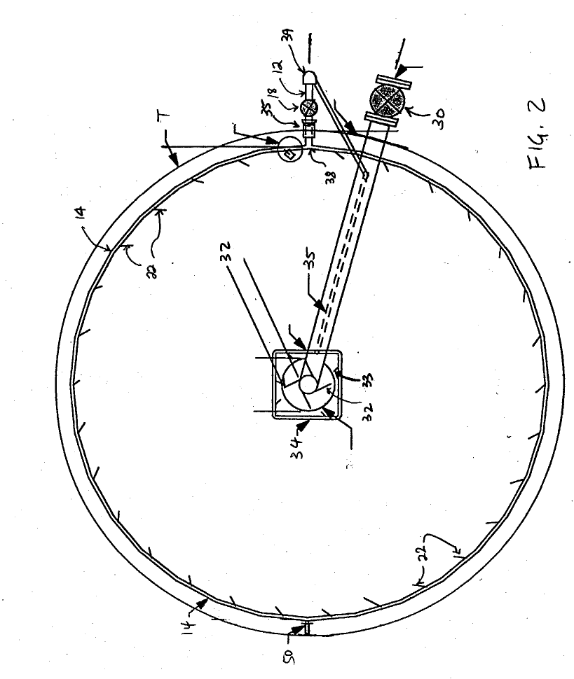

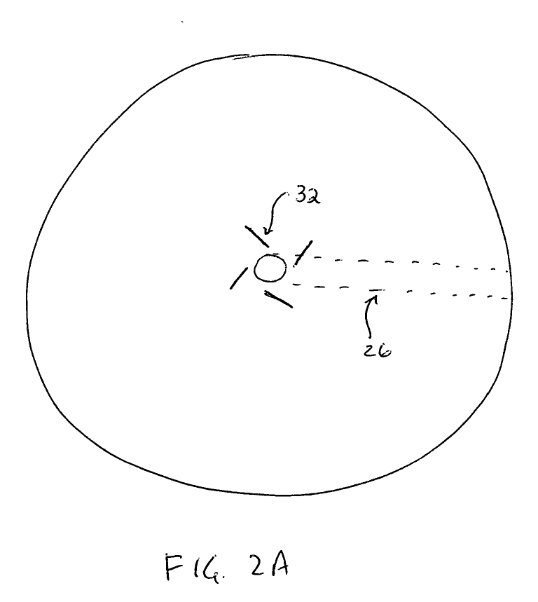

Sand is removed from the tank by means of a centrally positioned suction pipe (26) which has its intake opening (28) positioned slightly above the tank floor. The suction pipe leads outside of the tank and includes a valve (30) and conventional fittings to permit the connection of conventional vacuum truck hoses and couplings. In one embodiment, substantially vertical vanes (32) are fitted adjacent the suction pipe opening to direct sand and fluid into or towards the suction pipe opening. The vanes may be vertical or inclined. The vanes may be directed radially outward as illustrated or they may be positioned at an angle to a radial line as shown in FIG. 2A. In a preferred embodiment, four such vanes (32) are provided as shown in FIG. 22.

In one embodiment, an inner pipe ring (34) is provided in relative close proximity to the suction pipe opening which also includes a plurality of wash nozzles (33). The purpose of the inner pipe ring is to loosen sand which may have accumulated or compacted around the suction pipe opening during an initial phase of a sand removal procedure. Water flow to the inner pipe ring (34) is controlled by a separate valve (36) and is connected to the piping (12) of the upper and lower rings. Operation of the inner pipe ring may be only during an initial phase of a sand removal procedure or during all phases. The inner pipe ring (34) is illustrated in the Figures as being square, which facilitates fabrication from straight pipe and 90° elbow joints. However, the inner ring (34) may also be circular or any other functional shape. In a preferred embodiment, the inner ring nozzles are directed towards the vertical vanes (32).

In one embodiment, the upper pipe ring (14) is mounted to the tank by a connection (35) to the piping (12) coming from the exterior of the tank and a bracket (50) mounted to the interior of the tank at an opposing point.

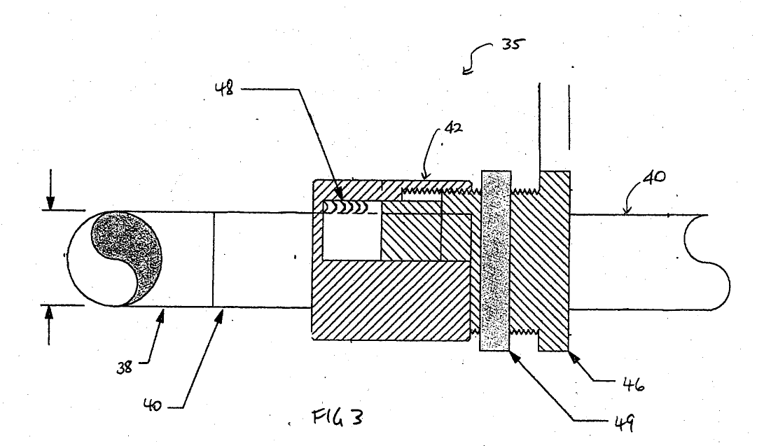

In a preferred embodiment, the upper pipe ring (14) is pivotally mounted to the tank so that the upper pipe ring (14) may be rocked about a substantially horizontal axis, across the diameter of the upper pipe ring. The piping (12) to the upper pipe ring may include a swivel 90 joint (3)9. A T-joint (38) permits coupling to the pipe ring (14) and is connected to a pipe (40) which extends through a packing body (42). The pipe (40) extends into a packing head (46) which is threaded into the packing body (42). V-groove packing (48), or other seal material, may then be provided to seal the packing body (42). As a result, the pipe (40) may rotate within the packing body (42) while maintaining the fluid integrity of the tank. A lock nut (49) may be provided as shown in FIG. 3. The mounting bracket (50) on the opposite side of the tank is fastened to the inner surface of the tank wall and may include a socket which accepts a rotatable pin attached to the upper pipe ring.

Rocking, or rotating, the upper pipe ring (14) may facilitate suspension of sand into the wash water and creation of the desired vortex. A grab bar (44) may be attached to the feed pipe (40) to facilitate manual rotation of the upper pipe ring (14).

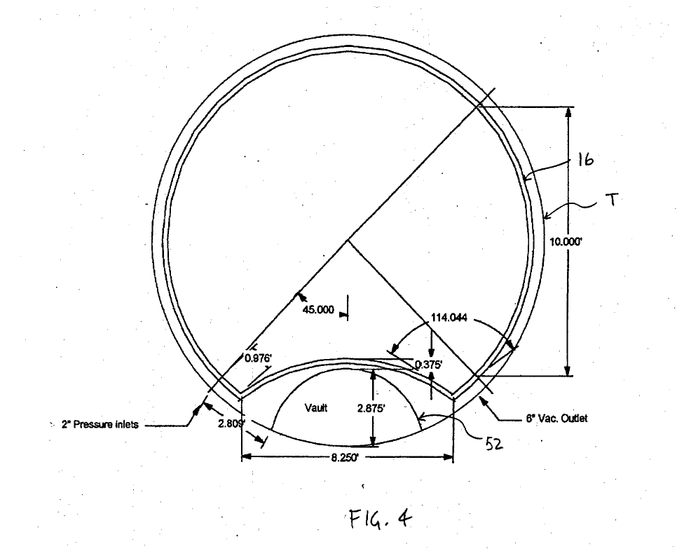

Some oil storage tanks incorporate an inner chamber (52) such as the EnviroVault ® (Envirovault Ltd., Elk Point, Alberta) as illustrated in FIG. 4. If necessary, one or both of the pipe rings (14, 16) may be modified as shown to accommodate an intruding structure within the tank.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. A particulate removal system for a vertically cylindrical fluid storage tank comprising:
(a) at least one nozzle disposed within the tank for directing a wash fluid in a circular motion within the tank;
(b) means for connecting the at least one nozzle with a supply of pressurized wash fluid;
(c) a particulate collection outlet centrally located within the tank.

2. The system of claim 1 further comprising a circular pipe ring concentrically disposed within the tank, wherein the at least one nozzle is provided on the pipe and the pipe delivers wash fluid to the at least one nozzle.

3. The system of claim 2 wherein the pipe ring comprises a plurality of nozzles directed inwardly and at an angle which would create a swirl or vortex.

4. The system of claim 3 wherein the pipe ring is pivotally attached to the tank, such that the pipe may rotate about a substantially horizontal axis.

5. The system of claim 2 further comprising a second circular pipe ring disposed concentrically within a lower section of the tank, the second circular pipe comprising a plurality of wash fluid nozzles and connected to a supply of pressurized wash fluid.

6. The system of claim 5 wherein the second pipe ring nozzles are directed inwardly and at an angle to create a swirl or vortex.

7. The system of claim 1 wherein the particulate collection outlet comprises a suction pipe and at least two radial vanes.

8. The system of claim 7 wherein the vanes-are substantially vertical.

9. The system of claim 1 further comprising at least one starter nozzle located proximate to the particulate collection outlet and connected to a supply of pressurized wash fluid.

10. The system of any one of claim 1, wherein at least one nozzle comprises a venturi nozzle.

11. A fluid collection tank comprising the system of claim 1.

12. A method of removing settled particulate matter from a fluid collection tank comprising the steps of:
(a) directing a pressurized wash fluid within the tank to mix with the particulate matter and create a fluid vortex;
(b) removing particulate matter and wash fluid by suction at the centre of the vortex.

13. The method of claim 12 using a system as claimed in claim 1.
